(19) United States
(12) Patent Application Publication
(10) Pub. No.: US 2004/0001902 A1
(43) Pub. Date: Jan. 1, 2004

(54) Device for vibrating and compacting

(76) Inventor: Harald Winkler, Helvesiek (DE)

Correspondence Address: Stephan A. Pendorf, Pendorf & Cutliff, P.O. Box 20445, Tampa, FL, 33622-0445, US

(21) Appl. No.: 10/183,115

(22) Filed: Jun. 26, 2002

(51) Int. Cl. B28B 1/087

(52) U.S. Cl. 425/432; 425/456

(57) ABSTRACT

The invention concerns a vibrating machine for vibrating and compacting of compactable materials, in particular raw concrete filled into concrete molds for concrete mold parts, preferably low water content raw concrete, wherein the vibrating machine is comprised of a machine base (1), an oscillator (6) and a vibrating table (4) which can be caused to vibrate by oscillations of the oscillator (6), upon which a concrete mold (16) for the concrete molded parts can be placed, wherein means are provided for coupling the concrete mold (16) and the vibrating table (4) to each other for reduction of noise. The means for coupling comprises a vacuum coupling (4, 13, 16), which draws the vibrating table (4) and the concrete mold (16) form locking towards each other during the vibrating process. The vacuum coupling is preferably comprised of the vibrating table, the base (19) of the concrete mold (16), a hollow space (17) between the vibrating table and the base of the concrete mold (16), as well as a vacuum seal (15) surrounding the hollow space.

### BACKGROUND OF THE INVENTION

1. Field of the Invention

The invention concerns a vibrating machine for vibrating and compacting compactable materials, in particular for raw concrete filled into concrete molds for concrete cast parts, and in particular low water content raw concrete, wherein the vibrating machine is comprised of a machine framework or base, an oscillator, and a table caused to vibrate by said oscillator, upon which table the concrete mold for the concrete cast parts can be placed, wherein means are provided for coupling the concrete mold and the vibrating table to each other for minimization of noise.

2. Description of the Related Art

This type of vibrating machine is known. Oscillation dampers or shock absorbers are provided between the ground and the machine base and between the machine base and the vibrating table. As oscillation dampers, there may be employed, for example, steel springs, selenium blocks or other conventional damping elements. For producing and shaping concrete parts, an empty concrete mold is placed upon the vibrating table and clamped to the vibrating table. For this one employs, for example, quick release clamps. Mounting irons or shims are introduced and fixed in the right height. Next, raw concrete is filled into the mold. In order to be able to quickly remove the concrete from the mold, that is, prior to setting or hardening of the concrete, referred to as fresh de-molding, one preferably employs so-called low water content concrete.

An oscillator transmits oscillations to the vibrating table and the concrete mold; the concrete mold is vibrated. This vibrating process is accompanied by a great production of noise with an acoustic level in the vicinity of approximately 115 dB. This type of noise level is unacceptable in enclosed work spaces. Nevertheless, work is carried out under these conditions, because no work process is known with lower sound levels.

### SUMMARY OF THE INVENTION

It is the task of the invention to provide a vibrating machine which, when operating with the same capacity, has a significantly lower sound level and lower emissions of vibration into the environment.

This task is inventively solved by a device with the characteristics according to claim 1. Advantageous refinements are set forth in the dependent claims.

The vacuum coupling is therein preferably comprised of a vibrating table, the lower side of the concrete mold, a hollow space between the vibrating table and the bottom side of the concrete mold as well as a vacuum seal encompassing the hollow space.

The force-locking connection of vibrating table and concrete mold reduces the sound level quite dynamically to an acceptable value of approximately 85 dB or less. The principle is comprised therein, that the base of the concrete mold and the vibrating table during vibration do not lift and separate and then again collide together, which is the case with known designs. The vacuum coupling connects the parts to each other substantially more solidly and thus prevents the lifting off followed by banging together. The significant reduction of the noise level is so great because the above mentioned 115 dB cannot occur, since as a result of the force-locking connection no air space, and therewith no bumping together of the parts, can result.

In accordance with a further development of the invention it is envisioned that the vibrating table is provided with a receiving side for receiving the concrete mold, said receiving side provided with a projecting vacuum seal, and a vacuum conduit which connects a vacuum pump device to the mold receiving surface. In a further development of the invention it is envisioned, that the vacuum seal is inlaid into a groove provided in the receiving surface, and projects with a sealing lip out of the receiving side. Beyond this, it is envisioned that this vacuum seal extends along the edge of the receiving surface. Such a sealing design achieves all requirements for a satisfactory sealing device between the vibrating table and the concrete mold.

According to a further development of the invention it is envisioned that the vibrating table is supported upon the machine base or framework via a rubber elastic, flexible air spring. The material of this rubber elastic air spring need not be rubber. It need merely have the elastic properties of rubber. By means of the air springs the sound level is again reduced by about 5 dB. According to a further development of the invention it is envisioned, that the vibrating table is supported by means of geometrically suitably arranged air bellows.

According to a further development of the invention it is envisioned that the oscillator is provided at the bottom side of the vibrating table. According to a further development, this could be an electric motor with an eccentric or unbalanced weight. It is however possible to produce the oscillations pneumatically, hydraulically, electro-magnetically or by means of an internal combustion engine.

### BRIEF DESCRIPTION OF THE DRAWINGS

The invention is described in greater detail on the basis of the figures. There is shown in:

FIG. 1 a side view of a shaking or vibrating machine with a vacuum connection, which is in communication with the receiving side of a vibrating table, and air springs, which support the vibrating table,

FIG. 2 the shaking or vibrating machine in top view, wherein the vibrating table is shown in partially broken-away view, in order to more clearly show the arrangement of a part of the air springs and the oscillator,

FIG. 3 an enlarged partial section through the vibrating table, wherein the vacuum seal and the vacuum connection can be seen,

FIG. 4 a top view upon the multipart concrete mold,

FIG. 5 a cross section through a concrete mold,

FIG. 6 a cross section through a natural stone/concrete composite.

### DETAILED DESCRIPTION OF THE INVENTION

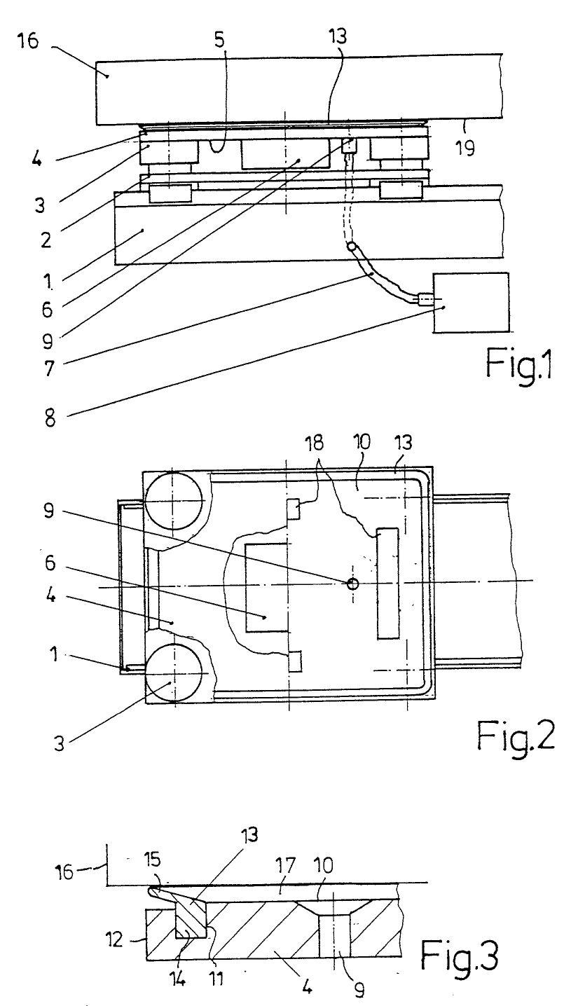

FIGS. 1 and 2 represent a shaking or vibrating machine for shaking and compacting raw concrete, in particular low water content raw concrete, in concrete molds for concrete mold parts, in side view. The vibration machine is however equally suitable for all materials which are compactable by vibrating. The vibrating machine includes a base 1 provided upon the ground, which is not shown. On this base 1 there is a vibrating base plate 2, upon which three approximately triangular arranged air springs 3 are supported. The number of the air springs and their arrangement is however variable and can be any suitable geometric manner. They are adapted to the statistic requirements of the shape being carried. The air springs 3 can be supported on their sides by not shown vertical guide cylinders. The air springs are comprised of rubber elastic, height adjustable, inflatable air bellows. The air bellows are comprised of a rubber-like material reinforced with fabric, but however could be comprised of other suitable materials.

A vibrating table 4 is supported by the air springs 3, and is in the form of a vacuum-clamp plate. The size and the geometry of the vibrating table, which, as described later, is utilized as a vacuum plate, depends upon the characteristics of the mold 16 to be seated thereupon. This can for example be round or trapezoidal. On the bottom side 5 of the vibrating table 4 there is an oscillator 6. This oscillator 6 can be comprised of a motor with an unbalanced weight. It is however likewise possible, to provide a pneumatic, hydraulic, electro-magnetic or internal combustion engine type oscillator. A vacuum line 7 is directed to the upper side of the vibrating table 4. This vacuum line 7 extends from a vacuum unit 8 to the vibrating table 4, through an opening 9 in the vibrating table 4, and up to the upper receiving side 10 of the vibrating table.

The vibrating table 4 is, as shown in FIG. 3, provided with a groove 11, which is recessed into the vibrating table on the receiving side 10 thereof. The groove extends, a certain distance from the edge 12 of the vibrating plate 4, along its edge 12. In this groove 11 is introduced a vacuum seal 13 with a seal foot 14. Above the upper side of the receiving surface 10 there projects a sealing lip 15 connected to the sealing foot 14.

For the production and shaping of concrete parts an empty concrete mold 16 is seated upon the vibrating table 4 on its bottom side 19. Thereafter, air is suctioned out of the hollow space 17 remaining above the receiving surface 10. Thereby, in a very short period of time, a force locking connection is produced between the concrete mold 16 and the vibrating table 4.

Next, raw concrete, preferably low water content concrete, is filled into the concrete mold. The air springs 3 are inflated. The vibrating table 4 and the concrete mold 16 lifted. Upon activation of the oscillator 6 the concrete mold 16 is brought into vibrational movement, which results in a compacting of the concrete. The concrete could however naturally also be flowable raw concrete. The compacting effect is the same. The advantage of the low water content concrete is comprised only therein, that immediately after the compacting step the mold can already be removed, while in the case of more fluid concrete one must wait one day prior to mold removal.

Carrying supports 18 are introduced in the receiving surface 10 of the vibrating table 4.

In the figures only one machine base is shown. One could however recognized from the interrupted edges on the right side of FIGS. 1 and 2 that it is possible to connect other machine units. This would be the case when the concrete mold 16 is very large and further supports would be recommended.

A particular advantage of this design is in the significant reduction of the sound level. The sound level is reduced, in the case of vacuum coupling, from approximately 115 dB to approximately 85 dB. The air springs provide a further reduction to approximately 80 dB.

A further advantage of the inventive device is also comprised therein, that in the case of maintaining the same power as devices known from the state of the art, a significantly higher compacting effect is produced. Therewith there results the advantage of a lower energy consumption with the inventive device, in the case that a relatively lower energy consumption is used for compacting.

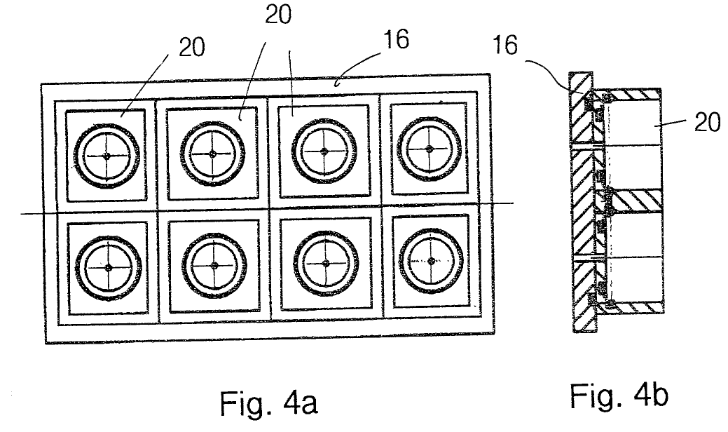

In FIG. 4 the concrete mold is shown from above. Herein there can be seen, that the concrete mold 16 is comprised of eight adjacent positioned receptacles 20, which can be respectively filled with concrete.

The inventive device can also be employed in order to produce so-called natural stone/concrete composites 21 (FIG. 6). Such natural stone/concrete composite comprise on the one hand a plate 22, which is comprised of natural stone or artificial stone. This plate 22 later forms the upper side of the composite stone. On the lower side of this plate 22 a thicker layer 24 of concrete is formed, for example 5 cm to 20 cm thick.

Since the inventive device provides a very high compacting capacity, it is possible in the case of production of natural stone/concrete composites first to lay the plate into the mold and subsequently thereto to fill the mold with low water content concrete. For better bonding between the concrete and the natural stone an adhesive layer 23 can be provided, which is applied to the back side of the plate prior to the introduction of the concrete into the mold.

By the high compacting of the low water content concrete the natural stone/concrete composite after compacting, however prior to setting or hardening of the concrete, is sufficiently shape-retentive and can set even after removal of the mold, so that immediately after the compacting of the concrete the mold can be immediately removed and utilized for further pre-manufacture of additional natural stone/concrete composites.

As adhesive between the stone plate and the concrete, either a single component or a dual component adhesive can be employed. Particularly preferred is an adhesive which is available under the name “Q-Bond”.

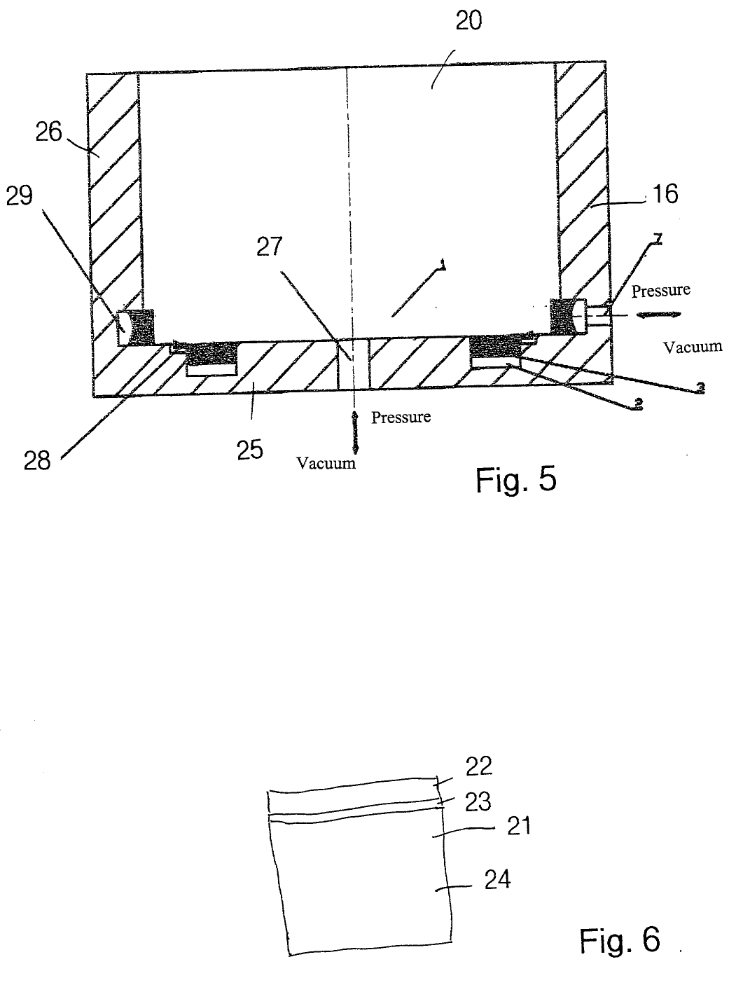

FIG. 5 shows a further embodiment of the concrete mold 16 in cross section. Herein the concrete mold includes a base 25 and side walls 26. A through hole or opening 27 is formed in the base. The shape of the structure is particularly suitable for the manufacture of the natural stone/concrete composites. Besides the opening 27 the mold includes a ring shaped seal 28 in the floor or base area and a circumscribing seal 29 in the wall area. If a natural stone plate 22 is introduced into the mold 16, 20, then this can be pulled and held by the vacuum, by means of which already the concrete mold is drawn to the vibrating table (FIG. 2, FIG. 3), also the floor 25 of the concrete mold 16 can be pulled and held. Therewith it is insured in each case, that the plate lies securely in the concrete mold 16 upon the base 25 of the concrete mold during the vibrating process.

By the circumscribing wall seal 29, which is preferably in the form of a pressure seal, it is beyond this possible to so seal the wall area of the plate, that no concrete can pass the edge of the plate and run to the upper side of the plate (the upper side of the plate is at this time on the side of the concrete mold floor).

So that the pre-manufactured natural stone/concrete composite can be released from the concrete mold, first the pressure in the circumscribing wall seal can be reduced (for example by vacuum), the seal thereby returns into the wall 26 and beyond this it is possible to introduce pressure through the inlet 27, preferably air pressure, into the concrete mold, so that the entire composite stone can be pushed in controlled manner out of the mold.

The ring shaped seal 28 in the base of the concrete mold ensures that a vacuum can form between the plate and the floor of the concrete mold.

1. Device for vibrating and compacting of compactable materials, in particular raw concrete filled into concrete molds for concrete mold parts, preferably low water content raw concrete, wherein the vibrating machine is comprised of a machine base (1), an oscillator (6) and a vibrating table (4) which can be caused to vibrate by oscillations of the oscillator (6), upon which a concrete mold (16) for the concrete molded parts can be placed, wherein means are provided for coupling the concrete mold (16) and the vibrating table (4) to each other for reduction of noise, thereby characterized, that the means for coupling is comprised of a vacuum coupling (4, 13, 16), which draws the vibrating table (4) and the concrete mold (16) form locking towards each other during the vibrating process, wherein the concrete mold (16) is comprised of multiple adjacent receptacles (20), into which respectively raw concrete to be compacted can be filled.

2. Device according to claim 1, thereby characterized, that the vacuum coupling is comprised of the vibrating table, the base (19) of the concrete mold (16), a hollow space (17) between the vibrating table and the base of the concrete mold (16), as well as a vacuum seal (15) surrounding the hollow space.

3. Device according to one of claims 1 and 2, thereby characterized, that the vibrating table (4) is provided on its receiving surface (10) with a vacuum seal (15) for the concrete mold (16), said seal projecting from the receiving surface, and a vacuum line (7) which provides communication between a vacuum pump unit (8) and the receiving surface (10).

4. Device according to one or more of claims 1 through 3, thereby characterized, that the vacuum seal (15) is seated in a groove (11) recessed in the receiving surface (10) and projects with a sealing lip (15) out of the receiving side (10).

5. Device according to one of claims 1 through 4, thereby characterized, that the vacuum seal (15) in the receiving surface (10) extends along the edge thereof (12).

6. Device according to one or more of claims 1 through 5, thereby characterized, that the vibrating table (4) is supported on the machine base (1) via rubber elastic, flexible air springs (3).

7. Device according to one or more of claims 1 through 6, thereby characterized, that the vibrating table (4) is supported by means of multiple geometrically appropriately arranged air springs (3).

8. Device according to one or more of claims 1 through 7, thereby characterized, that the vibrating table (4) is supported via three air springs (3) arranged in approximately a triangle.

9. Device according to one ore more of claims 1 through 8, thereby characterized, that the oscillator (6) is provided on the lower side (5) of the vibrating table (4).

10. Device according to claim 9, thereby characterized, that the oscillator (6) is an electric motor with an unbalanced weight.

11. Device according to claim 9, thereby characterized, that the oscillator (6) produces the oscillations pneumatically, hydraulically or via an internal combustion engine.

12. Device according to claim 9, thereby characterized, that the oscillator (6) produces the oscillations electro-magnetically.
